(19) United States
(12) Patent Application Publication
(10) Pub. No.: US 2007/0120372 A1
(43) Pub. Date: May 31, 2007

(54) LATCH MECHANISM

(75) Inventors: Jie Zhang, Shenzhen (CN); Chien-Li Tsai, Tu-Cheng (TW); Hung-Chun Lu, Tu-Cheng (TW); Wen-Kang Lo, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,630

(22) Filed: Sep. 1, 2006

(30) Foreign Application Priority Data
Nov. 14, 2005 (CN) 200520067922.0

(51) Int. Cl. E05C 9/00

(52) U.S. Cl. 292/8

(57) ABSTRACT

A latch mechanism includes a latching member and a button. The latching member is slidably installed in a cover unit. The latching member includes a hook for engaging with a base unit, a groove is defined in the latching member, and a slanted surface is defined adjoining the groove. The button is movably fixed to the cover unit. The button includes a pushing portion received in the groove of the latching member and engaging with the slanted surface adjoining the groove. The button can be operated to drive the latching member to slide for disengaging the hook from the base unit.

### FIELD OF THE INVENTION

The present invention relates to a latch mechanism, and more particularly to a latch mechanism for a portable computer.

### DESCRIPTION OF RELATED ART

Typically, an electronic device, such as a portable computer, includes a cover unit and a base unit pivotally connected with the cover unit, and a latch mechanism is provided to lock the cover unit to the base unit.

As disclosed in U.S. Pat. No. 6,115,239, a latch mechanism for locking a cover unit to a base unit, includes a latch frame movably installed inside the cover unit, a plurality of latches are formed on the latch frame at predetermined intervals and one end portion of each latch protrudes from a front surface of the cover unit, and a slide knob is operatively connected to the latch frame for concurrently operating the latches. The latches are inserted into and locked by latch grooves formed at positions corresponding to the latches on an upper surface of the base unit. The latches are urged against the base unit by elastic forces applied by double springs mounted on two ends of the latch frame. However, to open the cover unit, the slide knob is slid to overcome the elastic forces of the springs to move the latch mechanism for disengaging from the base unit. The slide force depends on friction between the slide knob and fingers of an operator. It is laborious for an operator to provide enough force to move a slide knob.

What is needed, therefore, is a laborsaving latch mechanism.

### SUMMARY OF THE INVENTION

An exemplary latch mechanism is provided for locking a cover unit to a base unit. The latch mechanism includes a latching member and a button. The latching member is slidably installed in the cover unit. The latching member includes a hook for engaging with the base unit, a groove is defined in the latching member, and a slanted surface is defined adjoining the groove. The button is movably fixed to the cover unit. The button includes a pushing portion received in the groove of the latching member and engagable with the slanted surface adjoining the groove. The button is operated to drive the latching member to slide for disengaging the hook from the base unit.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an exploded, isometric, inverted view of a latch mechanism with a cover unit in accordance with a preferred embodiment of the present invention, and the cover unit includes a first panel and a second panel;

FIG. 2 an enlarged, assembled view of FIG. 1 without the second panel of the cover unit;

FIG. 3 is similar to FIG. 2, but showing another state of the latch mechanism; and

FIG. 4 is a schematic, assembled and part-sectioned view of FIG. 1 with a base unit.

### DETAILED DESCRIPTION OF THE INVENTION

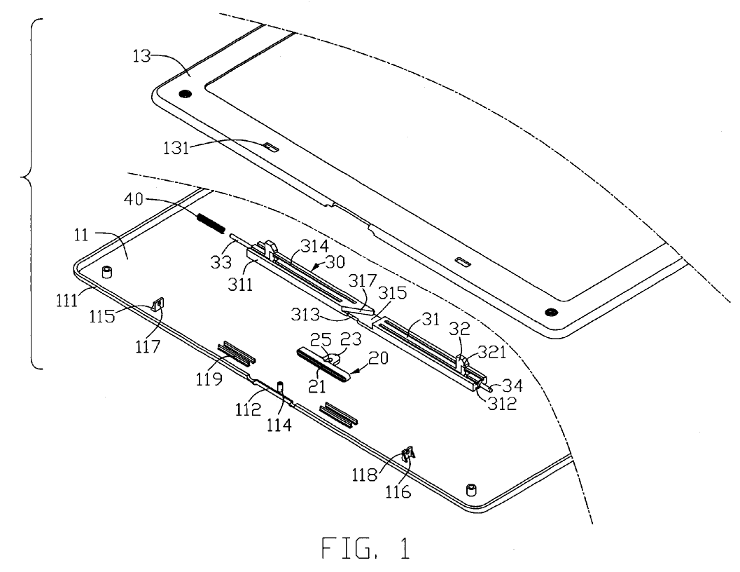

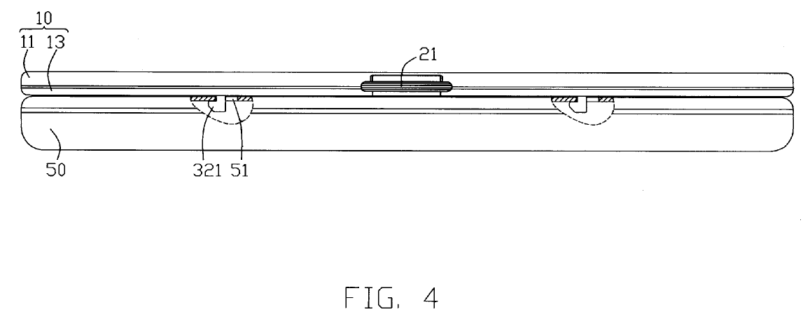

Referring to FIGS. 1 and 4, a latch mechanism is provided in accordance with a preferred embodiment of the present invention, for locking a cover unit 10 to a base unit 50 of an electronic device, such as a portable computer. The latch mechanism includes a button 20, a latching member 30, and an elastic member 40. In this embodiment, the elastic member 40 is a spring.

The cover unit 10 includes a first panel 11, and a second panel 13 having a pair of through holes 131 defined therein. The first panel 11 includes a front wall 111, and a recess 112 is defined inward in the middle of the front wall 111. A first plate 115 and a second plate 116 are formed oppositely on an inside surface of the first panel 11 adjacent to the front wall 111. A first guiding hole 117 is defined in the first plate 115, and a second guiding hole 118 is defined in the second plate 116 by cutting out a top portion thereof. Two pairs of sliding rails 119 are formed on the first panel 11 between the first plate 115 and the second plate 116. The pairs of sliding rails 119 are parallel to the front wall 111, and two pairs of sliding rails (not shown) are formed on an inside surface of the second panel 13 corresponding to the pairs of sliding rails 119 of the first panel 11. A post 114 is formed perpendicularly on the first panel 11 between the pairs of sliding rails 119 adjacent to the recess 112.

The button 20 is generally T-shaped. The button 20 includes a press portion 21, and a pushing portion 23 extending perpendicularly from a rear end of the press portion 21. A longitudinal hole 25 is defined in the pushing portion 23 corresponding to the post 114 of the first panel 11.

The latching member 30 includes a main body 31, a plurality of sliding slots 312 are defined in a bottom portion of the main body 31 corresponding to the sliding rails 119 of the first panel 11, and a plurality of sliding slots 314 are defined in a top portion of the main body 31 corresponding to the sliding rails of the second panel 13. The main body 31 includes a front surface 311, and a notch 313 is defined by cutting into a middle portion of the front surface 311 corresponding to the post 114 of the first panel 11. A groove 315 is defined in a middle section of the top portion of the main body 31 in communication with the notch 313, and a slanted surface 317 adjoining the groove 315 is defined between the front surface 311 and a rear surface of the main body 31. A pair of hooks 32 respectively having a hooking portion 321 protrude from the top portion of the main body 31, corresponding to the through holes 131 of the second panel 13. A first rod 33 and a second rod 34 extend from two opposite ends of the main body 31 respectively.

The base unit 50 defines a pair of latching slots 51, corresponding to the hooks 32 of the latching member 30.

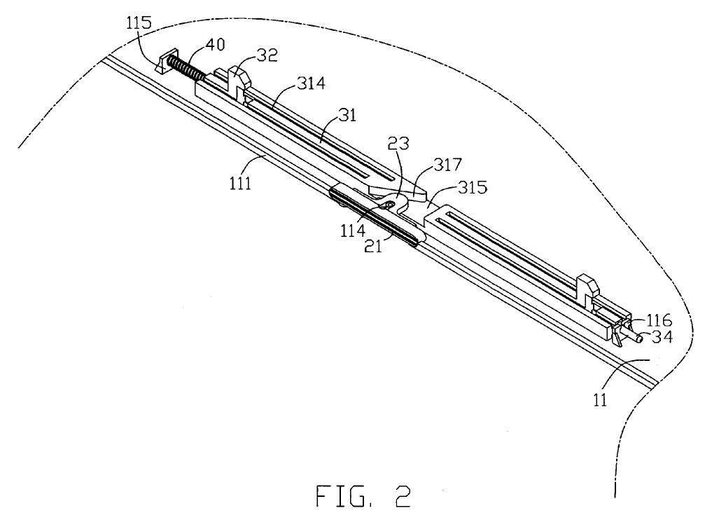

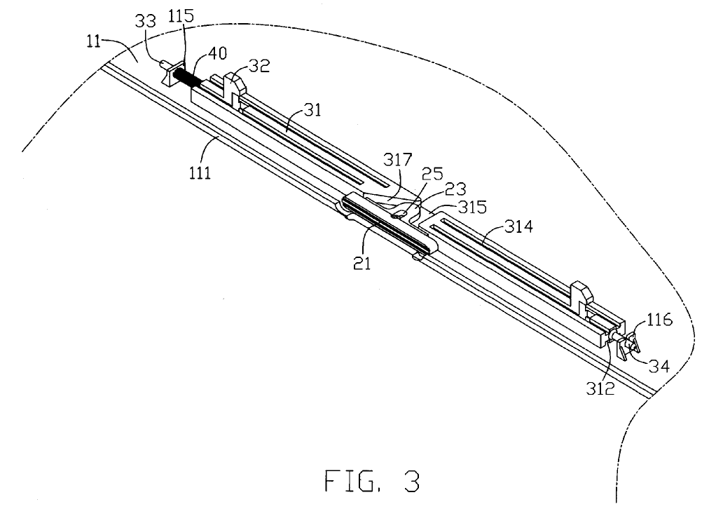

Referring also to FIGS. 2 and 3, in assembly, the elastic member 40 is placed around the first rod 33 of the latching member 30, and a free end of the first rod 33 extends through the first guiding hole 117 of the first plate 115 of the first panel 11, with two free ends of the elastic member 40 respectively engaging with the main body 31 of the latching member 30 and the first plate 115 of the first panel 11. The second rod 34 of the latching member 30 is pressed down into the second guiding hole 118 from the top portion of the second plate 116. The sliding rails 119 of the first panel 11 are received in the sliding slots 312 in the bottom portion of the main body 31 of the latching member 30, and the post 114 of the first panel 11 engages in the notch 313 of the main body 31, thereby the latching member 30 is fixed to the first panel 11 and capable of sliding along the sliding rails 119. The button 20 is mounted on the first panel 11 with the post 114 of the first panel 11 extending through the longitudinal hole 25 of the button 20. The press portion 21 of the button 20 is exposed from the recess 112 of the front wall 111 of the first panel 11, and the pushing portion 23 of the button 20 is received in the groove 315 of the latching member 30 and engages with the slanted surface 317 adjoining the groove 315.

Referring also to FIG. 4, the second panel 13 holds a Liquid Crystal Display therein, and the first panel 11 is fixed to the second panel 13 to cover one side of the Liquid Crystal Display. The hooks 32 of the latching member 30 extend outward from the through holes 131 of the second panel 13 respectively, thereby the cover unit 10 is fully assembled.

The cover unit 10 is pivotably attached to the base unit 50. The cover unit 10 is pivoted to cover the base unit 50 when the electronic device is not in use. When bottom surfaces of the hooking portions 321 of the hooks 32 abut against portions adjoining the latching slots 51 of the base unit 50 respectively, the cover unit 10 is downward pressed and the latching member 30 is therefore pushed to compress the elastic member 40 and slides toward the first plate 115 until the hooking portions 321 of the hooks 32 entirely enter the latching slots 51 respectively. After that the elastic member 40 is restored to push the latching member 30 to slide toward the second plate 116, top surfaces of the hooking portions 321 of the hooks 32 engage with the portions of the base unit 50 adjoining the latching slots 51. Thus, the cover unit 10 is locked to the base unit 50.

Referring further to FIG. 3, to unlock the cover unit 10 from the base unit 50, the press portion 21 of the button 20 is pressed to move the button 20 along the post 114 in a first direction perpendicular to the front wall 111. The pushing portion 23 of the button 20 actuates the slanted surface 317 of the latching member 30, and the latching member 30 is therefore pushed to slide in a second direction perpendicular to the first direction toward the first plate 115 and compress the elastic member 40. When the hooking portions 321 of the hooks 32 moves in corresponding latching slots 51 and disengage from the portions adjoining the latching slots 51 respectively, the cover unit 10 is ready to be pivoted open.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment of the invention.

What is claimed is:

1. A latch mechanism for locking a cover unit to a base unit, the latch mechanism comprising:
a latching member slidably installed in the cover unit, the latching member comprising a hook for engaging with the base unit, a groove defined therein, and a slanted surface adjoining the groove; and
a button movably fixed to the cover unit, the button comprising a pushing portion received in the groove of the latching member and engagable with the slanted surface adjoining the groove, wherein the button is capable of being operated to drive the latching member to slide for disengaging the hook from the base unit.

2. The latch mechanism as claimed in claim 1, wherein the cover unit comprises a first panel and a second panel fixed to the first panel.

3. The latch mechanism as claimed in claim 2, wherein a post is formed perpendicularly on the first panel, and the button defines a longitudinal hole for receiving the post.

4. The latch mechanism as claimed in claim 2, wherein the first panel comprises a front wall, a recess is defined inward in a middle portion of the front wall, and the button comprises a press portion exposed from the recess.

5. The latch mechanism as claimed in claim 2, wherein the first panel comprises a first plate defining a first guiding hole therein, and a second plate defining a second guiding hole therein, the latching member comprises a first rod and a second rod extending from two opposite ends thereof for extending through the first guiding hole and the second guiding hole respectively.

6. The latch mechanism as claimed in claim 5, further comprising an elastic member placed around the first rod for restoring the latching member, and two free ends of the elastic member respectively engaging with the latching member and the first plate.

7. The latch mechanism as claimed in claim 2, wherein a sliding rail is formed on the first panel, and the latching member defines a sliding slot cooperating with the sliding rail to facilitate sliding of the latching member.

8. An electronic device comprising:
a cover unit;
a base unit;
a latching member installable in the cover unit and capable of sliding along a first direction for engaging with the base unit; and
a button slidably receivable in the cover unit and operatively accessible from outside of the cover unit, the button capable of moving along a second direction generally perpendicular to the first direction to actuate the latching member to slide in the first direction for disengaging from the base unit.

9. The electronic device as claimed in claim 8, wherein the base unit defines a latching slot therein, and the latching member defines a hook engaging with the base unit through the latching slot.

10. The electronic device as claimed in claim 8, wherein the latching member defines a groove therein, a slanted surface is formed adjoining the groove, and the button comprises a pushing portion received in the groove for pushing the slanted surface to move the latching member.

11. The electronic device as claimed in claim 8, wherein the cover unit comprises a first panel and a second panel fixed to the first panel.

12. The electronic device as claimed in claim 11, wherein a post is formed perpendicularly on the first panel, the button is received between the first panel and the second panel, and the button defines a hole along the second direction for receiving the post and guiding the button to move in the second direction.

13. The electronic device as claimed in claim 11, wherein the first panel comprises a first plate with a first guiding hole, and a second plate with a second guiding hole, the latching member comprises a first rod and a second rod extending from two opposite ends thereof for extending through the first guiding hole and the second guiding hole respectively.

14. The electronic device as claimed in claim 13, further comprising an elastic member placed around the first rod for restoring the latching member, and two free ends of the elastic member respectively engaging with the latching member and the first plate.

15. The electronic device as claimed in claim 11, wherein a sliding rail is formed on one of the first panel and the second panel along the first direction, and the latching member defines a sliding slot corresponding to the sliding rail to allow the latching member to slide along the sliding rail.

16. An electronic device comprising:
a base unit;
a cover unit pivotably attached to the base unit, the cover unit comprising a pair of panels;
a latching member configured for locking the cover unit with base unit, the latching member comprising a main body slidably attached between the panels, and a latching portion configured for engaging with the base unit to thereby lock the cover unit with the base unit; and
a button slidably attached between the panels and being capable of driving the main body of the latching member to slide for disengaging the latching portion from the base unit.

17. The electronic device as claimed in claim 16, wherein the button is moveable in a first direction to drive the latching member to slide in a second direction perpendicular to the first direction.

18. The electronic device as claimed in claim 17, wherein an elongated slot is defined in one of the cover unit and the button, and a post is formed at the other one of the cover unit and the button is slidable with respect to the elongated slot in the first direction.

19. The electronic device as claimed in claim 18, wherein an elastic member is attached between the cover unit and the latching member for drive the latching member to return to its orignal position after the button releases the latching member.

20. The electronic device as claimed in claim 16, wherein one of the panels is configured for holding a Liquid Crystal Display therein, and the other one of the panels is configured for covering one side of the Liquid Crystal Display.
